(19) United States
(12) Patent Application Publication
(10) Pub. No.: US 2012/0284327 A1
(43) Pub. Date: Nov. 8, 2012

(54) APPARATUS AND METHODS FOR PROVIDING REAL TIME ADVICE ONLINE

(75) Inventor: William W. Graham, JR., Mill Valley, CA (US)

(73) Assignee: CBS INTERACTIVE, INC., San Francisco, CA (US)

(21) Appl. No.: 13/101,800

(22) Filed: May 5, 2011

(51) Int. Cl. G06F 15/16

(52) U.S. Cl. 709/203

(57) ABSTRACT

Various embodiments for providing real time advice online are described. In one or more embodiments, an online host may register willing users as advisors for a topic of a page at a website. The online host may later detect when an advisor is online. When another user requests live advice from a web page, the online host may select an online advisor for the topic of the web page from which the request came. The online host may communicatively couple the requesting user and the online advisor. Other embodiments are described and claimed.

### BACKGROUND

Many websites, such as online storefronts and consumer information sites, provide information, reviews, frequently asked questions (FAQS) and the like about products, services, or other content. The information may not, however, answer all potential questions that a consumer may have. In some cases, online forums may be available to ask questions and receive answers from actual users of a product. However, responses on forums may be delayed by hours or days, if any responses are received at all. Some websites provide the ability to “chat” live with a store representative, typically via a text-based instant messaging or chat interface. Store representatives, such as sales clerks, may not have real-world experience with a product, or may not be allowed to provide negative or non-favorable information about a product. Accordingly, there may be a need for an improved apparatus and methods for connecting those with questions to informed community members in real time.

### BRIEF DESCRIPTION OF THE DRAWINGS

FIG. 1 illustrates a first system for providing real time advice in accordance with one or more embodiments.

FIG. 2 illustrates a second system for providing real time advice in accordance with one or more embodiments

FIG. 3 illustrates an online host in accordance with one or more embodiments.

FIG. 4 illustrates an example of a graphical user interface providing real time advice in accordance with one or more embodiments.

FIG. 5 illustrates an embodiment of a graphical user interface for providing real time advice in accordance with one or more embodiments.

FIG. 6 illustrates a logic flow in accordance with one or more embodiments.

FIG. 7 illustrates a computing architecture in accordance with one or more embodiments.

### DETAILED DESCRIPTION

Various embodiments are directed to providing real time advice online by connecting individuals seeking information with informed individuals. Embodiments may include an online host that keeps track of “advisor” individuals who are willing to answer the questions of others on a product or other content. The online host may detect when an advisor is online. When another individual requests additional information, the online host may connect the individual to an advisor via a communication interface in real time.

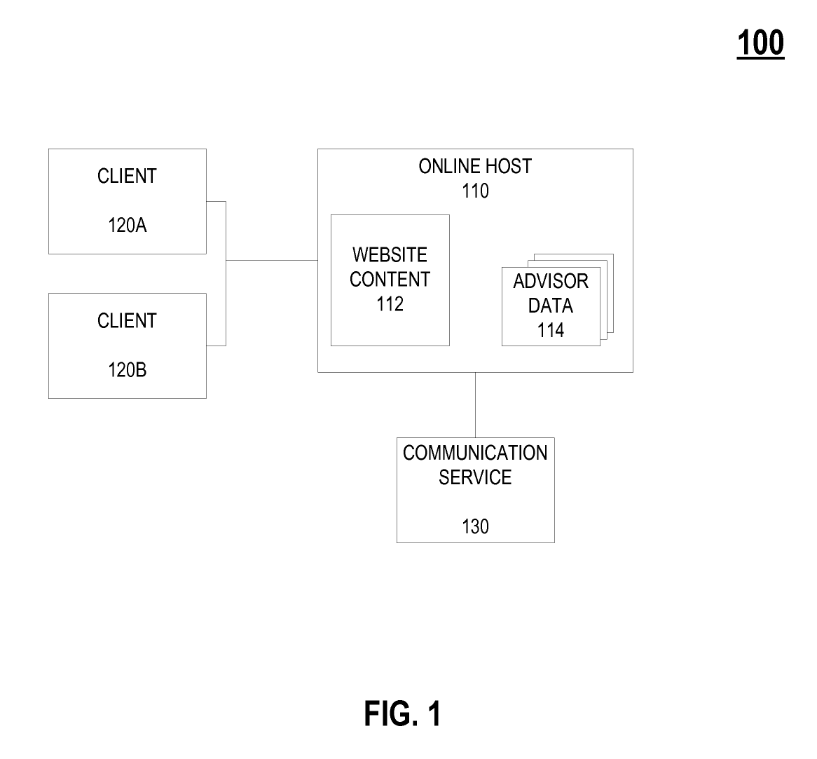

FIG. 1 illustrates a system 100 to provide real time advice online. In one embodiment, for example, the system 100 may comprise a computer-implemented system having multiple components, such as online host 110, client 120, and communication service 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The computing entities or devices of system 100 may be communicatively coupled via a network, which may be implemented via various types of communications media, including wired or wireless communications media. The network may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The computing entities or devices of system 100 may include various types of standard communication elements designed to be interoperable with the network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between computing entities or devices of system 100 can be in the form of a data packet adapted to be transmitted between two or more computer processes. The data packet may include a cookie and/or associated contextual information, for example.

In an embodiment, system 100 may include online host 110. Online host 110 may comprise a network server implementing a website hosting application, a web browser, or other suitable application for serving content to clients, such as client 120. A website may include one or more web pages of text, images, video, audio, hyperlinks, and/or other content types formatted to be viewed in an application such as a web browser, for example, Internet Explorer by Microsoft Corp., Safari by Apple Inc., or Chrome by Google. The pages may include, for example, hypertext markup language (HTML) coded pages, extensible markup language (XML) coded pages, JAVA applets, plain text, and so forth, or a combination thereof.

Online host 110 may serve a number of different web pages containing varied website content 112. In some cases, the online host 110 may be operated by an entity, such as a corporation, association, or individual, and hosted primarily from one network address. An online host, such as online host 110, may serve a variety of types of websites, such as, without limitation, a news site, an online storefront, a consumer product information site, a blog, a social networking site, a gaming site, a user forum site, an entertainment site, a sports site, a professional sports site, a college sports site, a high school sports site, a financial services site, a financial products site, and other websites aggregating a certain type or genre of information.

Website content 112 may include one or more kinds of content. For example, website content 112 may include consumer information, news, multimedia content, lifestyle content, entertainment content, merchandise, and/or product content.

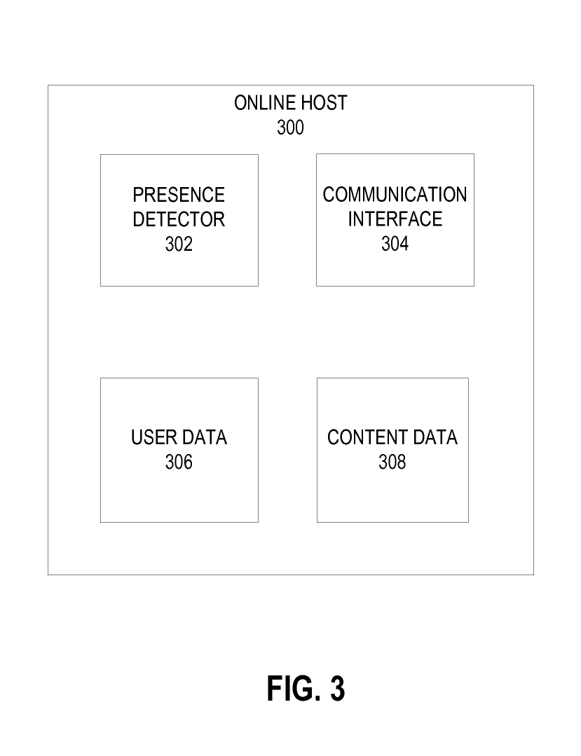

Online host 110 may store information about users that view website content 112 via a client 120. The stored information may include identifying information about a user, such as a client internet protocol (IP) address, an assigned anonymous unique identifier, or a unique user name and password. The stored information may further include information about a user's activity at the online host, such as items purchased, content categories viewed, messages posted, frequency of visits, and so forth. In an embodiment, online host 110 may request input from a user about whether the user would like to become an advisor at the online host. Information about users that opt to become advisors may be stored in advisor data 114. Advisor data 114 may include some or all of the stored information about users. An embodiment of online host 110 is discussed in further detail below with respect to FIG. 3.

Client 120 may be a wired or wireless computing device operating a browser, application viewer or other application program suitable for receiving and displaying content served by online host 110. Client 120 may receive and respond to control directives from a user, for example, input from an input device that causes the browser to connect to a specific website, download a file, fill out a form, follow a hyperlink, and so forth. Client 120 may receive and store information about the user's activity online. For example, client 120 may store a browser history for a browser application operating on client 120. The browser history may maintain a list of all of the website addresses or uniform resource locators (URLs) visited by the user within a certain time period. Client 120 may receive and store cookie files from websites visited, including from online host 110. The cookie files may record actions taken at a particular website, including links followed, search strings entered, a product purchased, and/or metadata associated with the web pages visited at the website. Client 120 may also keep a record of input commands received from a user, output presented on a display for the user, biometric information about the user, sensor information for various sensors implemented by the client 120 (e.g., proximity sensors, motion sensors, environmental sensors, and so forth), applications executing on the client 120, state information for the client 120, and any other information that may assist in identifying the user's presence and activity online. Additionally or alternatively, another network device may record information about the user's behavior online, such as online host 110. The embodiments are not limited to these examples.

System 100 may further include a communication service 130. Communication service 130 may include an application that allows users of different client devices to communicate with each other. For example, if a user of client 120A opts to be an advisor at online host 110, and a user of client 120B requests more information while at online host 110, online host 110 may connect the user of client 120B with the user of client 120A conversationally via communication service 130. In an embodiment, communication service 130 may be a third-party application, such as a text-based instant messaging chat application. Examples may include Microsoft Corp.'s Windows Live Messenger, Google Talk, Yahoo! Chat, America Online Instant Messenger (AIM), an Internet Relay Chat (IRC) application, and the like. Communication service 130 may provide video chatting and/or audio chatting, for example, via voice over internet protocol (VOIP), such as with Skype, or using other network connections, such as with Apple Inc.'s FaceTime. In an embodiment, communication service 130 may be a component of online host 110. The embodiments are not limited to these examples.

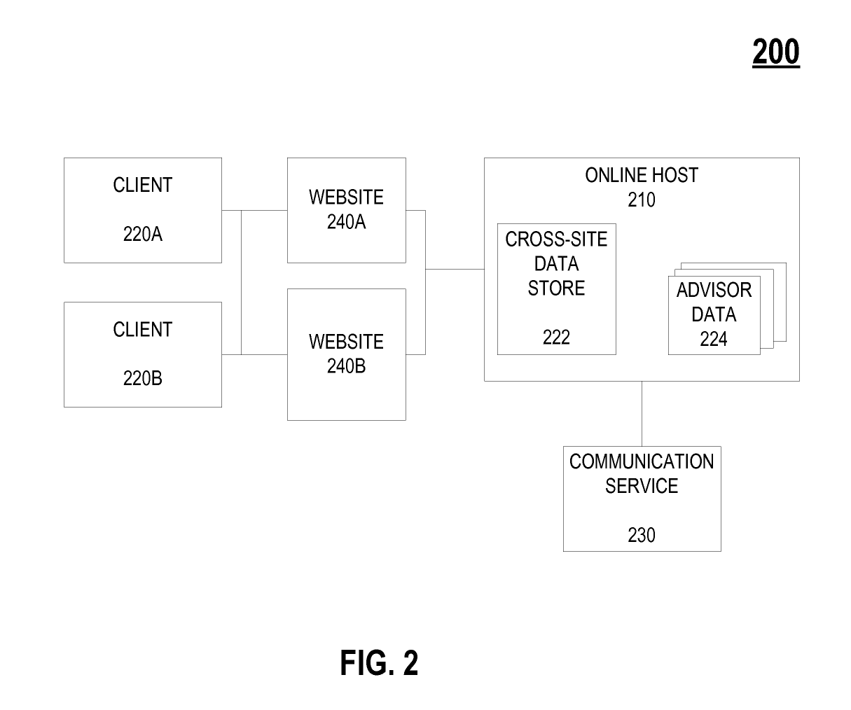

FIG. 2 illustrates a system 200 to provide real time advice online. System 200 may be similar to system 100 with the following differences. System 200 may include two or more different websites 240A, B hosted from the same domain. Website 240A, B may be owned or operated by one entity.

Online host 210 may be associated with website 240, that is, online host 210 may be communicatively coupled to websites 240A, B. Online host may reside in the same domain space as websites 240A, B. Online host 210 may receive presence information about an advisor from a website 240. For example, when an advisor logs in to a website 240 via a browser operating on a client 120, website 240 may pass the log in information, e.g. name and password, to online host 210. Receiving the log in information may serve to inform online host 210 that the advisor using that log in information is online. Online host 210 may use the log in information to retrieve advisor data from advisor data 224. In an embodiment, when a client 220 requests to load a page from a website 240, website 240 may read a cookie file placed on client 220 and determine that the client 220 corresponds to an advisor uniquely identified in the cookie, and that the advisor is online. Website 240 may then pass the presence information, e.g. the identifier for the advisor, and an “online” status, to online host 210. The embodiments are not limited to these examples.

Online host 210 may include a cross-site data store 222 that may store information about content and users across multiple websites 240. Cross-site data store 222 may be accessible to websites 240 for writing to and/or reading from. Cross-site data store 222 may store the interactions of a uniquely identified user with some or all of the websites 240. For example, when a user starts interacting with website 240A, website 240A and/or online host 210 may collect and store information about the interactions in cross-site data store 222. The collected information may include, for example, uniform resource locations (URLs) visited, search strings entered, products purchased, comments entered, the categories of products viewed, tags or keywords for content viewed, a previous URL visited, and so forth.

When the user moves to interacting with website 240B, website 240B and/or online host 210 may continue to collect information about the interactions, and store the information with the previously collected information in cross-site data store 222, indexed to the same user. In this manner, online host 210 may track user presence across different network applications, services or devices. When an advisor is online, for example browsing website 240A, online host 210 may therefore be able to indicate to website 240B that the advisor is online.

Advisor data 224 may be analogous to advisor data 114, e.g. advisor 224 may be a subset of user data stored about users that have agreed to be advisors for one or more topics. Communication service 230 may be analogous to communication service 130.

FIG. 3 illustrates an embodiment of an online host 300. Online host 300 may be a representative embodiment of online hosts 110 or 210. Online host 300 may include one or more functional components, such as presence detector 302 and communication interface 304. Online host 300 may further include user data 306 and content data 308.

User data 306 may include information about users that visit a website in communication with online host 300. The information about a user may be obtained via the user's interactions with a client, for example, text entered with an input device, hyperlinks selected with an input device, menu items selected with an input device, and so forth. The user information may include a unique identifier, assigned by online host 300, or a unique user name and password selected by the user. User data 306 may further include information about the user's activity at online host 300 or at associated websites, such as websites 240. The information about activity may include, for example, items purchased, content categories viewed, messages posted, frequency of visits, and so forth. In an embodiment, user data 306 may further include an indication, such as a flag, of whether the user has elected to be an advisor for online host 300. In an embodiment, user data for advisors may be a subset of user data 306, or may be maintained separately as advisor data, e.g. advisor data 114 or 214. User data 306 for advisors may further include preferred communication interface information, such as chat handles, email addresses, phone numbers, and the like.

Content data 308 may include, for example, website content 112. Content data 308 may include text, images, video, scripts and the like. Content 308 may include hypertext markup language (HTML) coded files, extensible markup language (XML) coded files, Javascript files, and so forth, that may format content to display on a client, for example, using a web browser application. Content data 308 may further include data about the content. In an online storefront, for example, content data 308 may include product information, including product specifications, inventory status, reviews, and so forth. Content data 308 may include metadata tags that include information about the content. For example, for a webpage that displays product information, metadata tags may include the product type, e.g. “keyboard”, a specific model number, a manufacturer name, and so forth. For a webpage that displays news content, metadata tags may include, for example, category, e.g. “local news,” topic, e.g. “environment,” and so forth. The embodiments are not limited to these examples.

In an embodiment, user data 306 and content data 308 may be linked, e.g. as data tables in a relational database. Users that are advisors may be linked to the item or topic for which they are an advisor. A user table may refer to content data tables for the topics that a user is an advisor for. A content data table for a topic may refer to the users that are advisors for that topic. The embodiments are not limited to these examples.

Online host 300 may include a presence detector 302. Presence detector 302 may register users as advisors and detect when an advisor is online. Registering a user as an advisor may include, for example, asking a user to be an advisor. A user may be asked, for example, when the user creates a new user name and password. Asking the user may include displaying a message with selectable inputs for “yes” and “no.” Asking the user may include sending the user an e-mail message, a text message, an instant message, and the like, with links or information on how to opt-in to being an advisor. Determining whether to ask the user to be an advisor may include monitoring a user's activity at the online host, or at websites in communication with the online host, and asking the user to be an advisor once the user has visited the online host a specified number of times. Presence detector 302 may monitor, for example, the number of page views from a user of a product area, category or topic in a time period before asking the user to be an advisor. Asking the user to be an advisor may include asking the user to be an advisor when the user purchases a product, posts a comment or review, or otherwise interacts with the online host or website. If a website has pages where a user can indicate that the user owns or has used a product, that the user is a “fan” of a brand, product, service or group, or is otherwise familiar with the website page content, then online host 302 may ask the user to be an advisor when the user indicates that familiarity.

When a user elects to be an advisor, registration may include assigning a unique identifier (ID) for the user (or using a previously made user name and password) and storing data about the user, for example, in user data 306 or advisor data 114, 214. The data stored may include at least the unique ID, and a communications “handle,” e.g. a chat ID, an email address, or a phone number, to be used by a communications interface, such as communication service 130, 230. The data may further include at least one topic area that the advisor is willing to assist with.

In an embodiment, a user may become an advisor on an ad hoc basis, without having to register or be registered. For example, if a particular user has a question, online host 300 may ask all users that are online whether they would like to help answer a question. Any willing user at that time may opt-in to being an advisor for the one question or session with the particular user.

Once a user is registered as an advisor, presence detector 302 may detect when the advisor is online at later times. In an embodiment, presence detector 302 may detect online presence when an advisor logs in with a user name and password. In another embodiment, presence detector 302 may detect online presence by examining a cookie file when a client loads a web page served by online host 300 or a website in communication with online host 300. Once the presence of an advisor is detected, presence detector 302 may continue to monitor the advisor's activity at the online host or at websites in communication with the online host. An advisor may be considered to be available for some time period after the last detected activity, for example, for five seconds after the last page load.

In an embodiment, online host 300 may include communication interface 304. In one embodiment, communication interface 304 may be a complete application for facilitating communication between a user and an advisor, for example, a chatting application. In another embodiment, communication interface 304 may provide an interface to a third party communication service, such as communication service 130, 230. The embodiments are not limited to these examples.

When a user is viewing a website page at online host 300 or in communication with online host 300, the user may select an option on the page to ask for live help. Presence detector 302 may search the advisors that are currently online for advisors that can help with the topic associated with the page the user is viewing. If there is more than one advisor available for the topic, presence detector 302 may display a list of available topic advisors to the user, and receive a selection of one of the advisors. Presence detector 302 may then use communication interface 304 to connect the user with the selected advisor for live communication. If only one advisor is online for the topic, presence detector 302 may use communication interface 304 to connect the advisor and the user without providing a selection list.

The components of online host 300 may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Examples of connections may include parallel interfaces, serial interfaces, and bus interfaces.

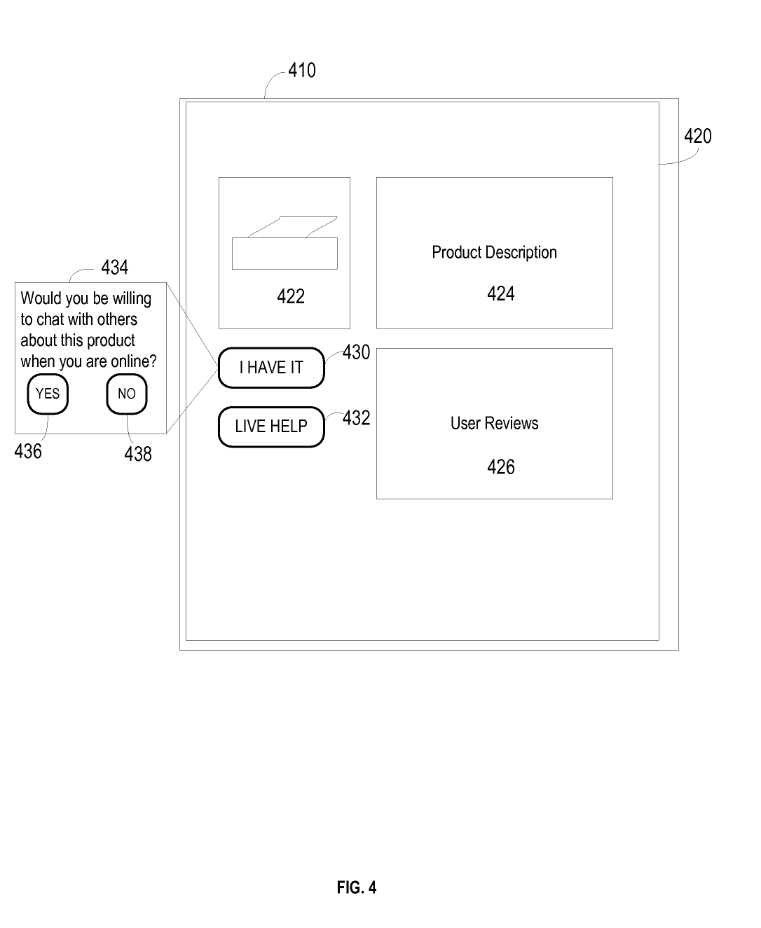

FIG. 4 illustrates an embodiment of a web page that provides real time advice according to embodiments. Web page 420 may be displayed in a browser window 410 on a client device, such as client 120. Web page 420 may be a product information page, for example, at an online storefront website, or a consumer products review website. Web page 420 may include various components, such as, but not limited to, an image 422, a product description field 424, and a user reviews field 426. Web page 420 may further include an “I have it button” 430 and a “live help” button 432.

“I have it” button 430 may receive a selection, such as a mouse click, from a user that owns the product. The functionality of button 430 may be implemented in other ways, for example, as a menu item on a menu that appears when an alternate selection means is used, e.g. a right-click on a mouse. Button 430 may be used to indicate other types of familiarity, instead of ownership, such as prior use of a product, completion of a game, completion of a series of books, membership in an organization, and so forth.

Receiving a selection of “I have it” button 430 may cause presence detector 302 to ask the user that selected the button to be an advisor for the product shown on web page 420. For example, presence detector 302 may open a dialog box 434 having a yes button 436 and a no button 438. If the user selects yes button 436, then presence detector 302 may proceed to register the user as an advisor. Other ways to ask the user to be an advisor may be used. For example, a new web page or a pop-up window may be opened, or the current web page may refresh to display the request and input items directly on the page. The embodiments are not limited to these examples.

Registering the user as an advisor may occur without further user input, for example if the user already has a unique ID at the website and the online host has detected which user is viewing web page 420. If the user is new to the online host, then additional input may be requested from the user, for example, on a new web page or in a dialog box where the user may enter identifying information, such as a user name.

“Live help” button 432 may receive a selection from a user that would like to communicate with an advisor at that moment. For example, the user may have a question about the product that is not answered in product description 424 or in user reviews 426. Receiving a selection of “live help” button 432 may cause presence detector 302 to search for advisors that are online for the product on web page 420. Presence detector 302 may select an online advisor, or allow the user to select one, and then may connect the user and the advisor for further communication.

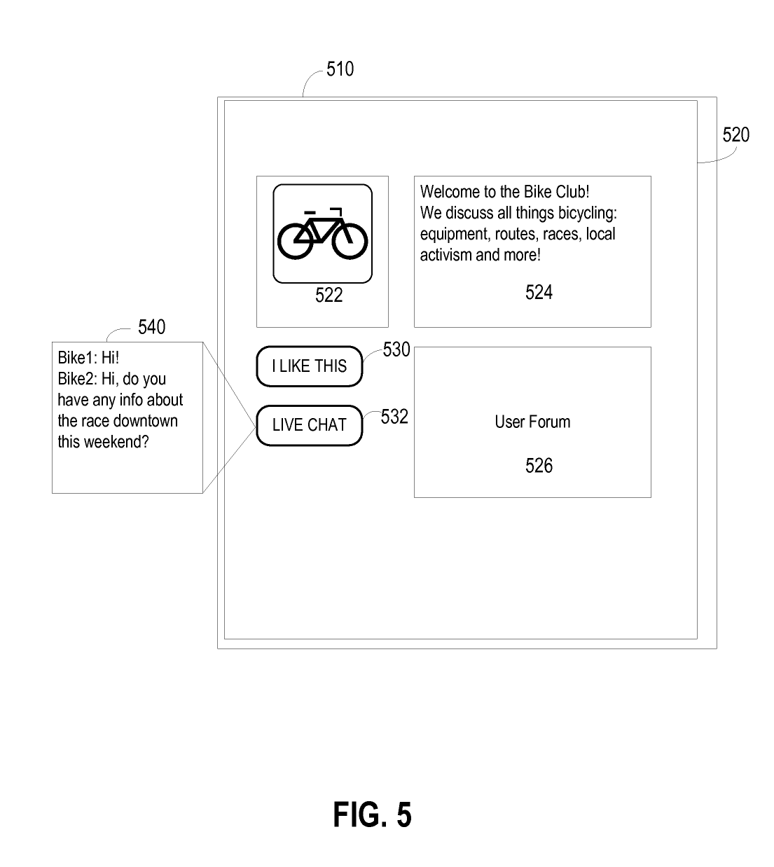

FIG. 5 illustrates an embodiment of a web page that provides real time advice according to embodiments. Web page 520 may be displayed in a browser window 510 on a client device, such as client 120. Web page 520 may be belong to an organization, for example, a bicycling club as shown. Web page 520 may include one or more components, such as an image 522, a descriptive field 524 and a user forum 526. Web page 520 may have an “I like this” button 530 and a “live chat” button 532. Button 530 may be analogous to the “I have it” button of FIG. 4, where a user may indicate familiarity with the content of the page. Selection of button 530 may prompt a request to register the user as an advisor, as described with respect to FIG. 4.

Button 532 may be analogous to “live help” button 432 in FIG. 4. Selection of button 532 may prompt presence detector 302 to search for and select an advisor that is online for the web page. When an advisor is selected, a chat window 540 may open between the advisor and the requesting user.

Embodiments may be used in a variety of scenarios. The term “advisor” may refer to those with experience or specific information about a topic, or more generally to those who are willing to have others communicate with them about a topic when the advisor happens to be online. In one example, the website may be a sports website for general sports information, information about a specific sport, or information about a specific team. Viewers of the website may opt to become advisors when they are willing to discuss the topic of the website with others. In another example, the website may be a news website. Readers of the website may be asked to become advisors when the online host associated with the news website detects that a reader has read some threshold number of articles about a topic, for example, a reader has viewed five articles about a governor's educational agenda within one week. In another example, the website may be an entertainment website that serves streaming media, such as video, and that may also serve fan forums, and/or an online store for entertainment branded merchandise. An entertainment consumer may be asked to become an advisor, for example, after viewing a movie, purchasing clothing related to the movie and/or posting a message on a social networking page for the movie. Many other examples are possible, where individuals with similar interests may want to communicate with each other when they are online, without necessarily having to register with a chat service.

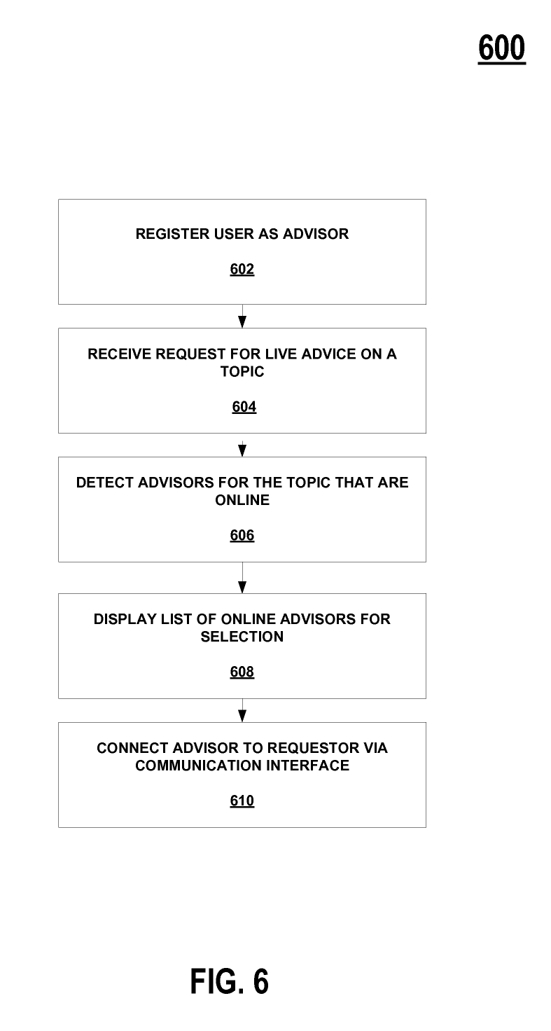

FIG. 6 illustrates a logic flow 600 in accordance with one or more embodiments. The logic flow 600 may be performed by various systems and/or devices and may be implemented as hardware, software, and/or any combination thereof, as desired for a given set of design parameters or performance constraints. For example, the logic flow 600 may be implemented by a logic device (e.g., processor) and/or logic (e.g., threading logic) comprising instructions, data, and/or code to be executed by a logic device. For purposes of illustration, and not limitation, the logic flow 600 is described with reference to FIGS. 1 and 3. The embodiments are not limited in this context.

In various embodiments, the logic flow 600 may register a user as an advisor in block 602. For example, online host 110 may register users as advisors after receiving an opt-in response from a user in response to asking the user to be an advisor. Online host 110 may ask a user, for example, when the user creates a new user name and password, via a client device, for a website associated with online host 110. Online host 110 may monitor a user's activity at the online host, or at associated websites, and may ask the user to be an advisor once the user has visited the online host a specified number of times. Online host 110 may ask a user to be an advisor when the user purchases a product, posts a comment or review, or otherwise interacts with the online host or associated website. If a website has pages where a user can indicate that the user owns or has used a product, that the user is a “fan” of a brand, product, service or group, or is otherwise familiar with the website page content, then online host 110 may ask the user to be an advisor when the user indicates that familiarity.

When a user elects to be an advisor, registration may include assigning a unique identifier (ID) for the user (or using a previously made user name and password) and storing data about the user, for example, in advisor data 114. The data stored may include at least the unique ID, and a communications “handle,” e.g. a chat ID, an email address, or a phone number, to be used by a communications interface, such as communication service 130. The data may further include at least one topic area that the advisor is willing to assist with.

In various embodiments, the logic flow 600 may receive a request for live advice on a topic in block 604. For example, a website page may include a link or selectable object that may be clicked or selected when a user of the page would like to communicate with an advisor online. Online host 110 may receive a request for live advice when the link or selectable object is selected.

In various embodiments, the logic flow 600 may detect advisors that are online for the topic in block 606. In response to receiving the request in block 604, online host 110 may detect all of the users that are online, determine whether the users are advisors, and determine whether the advisors are advisors for the topic associated with the web page from which the request came.

Online host 110 may detect online presence, for example, when a user logs in with a user name and password. In another embodiment, online host 110 may detect online presence by examining a cookie file when a client device loads a web page served by the online host or an associated website. Continued online presence may be detected by, for example, additional page loads and input device activity while a browser window with a site page remains open. Once a unique user is detected online, online host 110 may refer to advisor data 114 to determine whether the detected user is an advisor and for which topic. Alternatively, once a unique user is detected online, online host may search website content 112 to obtain a list of possible advisors for the topic, and compare the possible advisors to the users detected online.

In an embodiment, online host 110 may alert all online users that someone would like to discuss a topic, regardless of registration. Any online user that is willing to participate may opt to communicate with the requesting user, without having to register with online host 110.

In various embodiments, the logic flow 600 may display a selection of online advisors in block 608. In particular, when more than one advisor is available at one time for a topic, online host 110 may allow the requesting user to select an advisor. In an embodiment, using additional information, such as a time zone, geographic location, connection speeds, or other topic areas of the available advisors, online host may provide the additional information in the display to allow the requesting user to select the most appropriate advisor for their needs. In an embodiment, online host 110 may use the additional information to calculate a relevance score, and may sort the list according to the relevance. For example, an advisor in the same city may be more relevant for the requesting user than an advisor in a different state. An advisor that has two or more of the same products in common with the requesting user may be more relevant than an advisor with only one product in common. In an embodiment, requesting users may be able to rate the communication they had with an advisor, e.g. from most helpful to least helpful on the topic. Advisors having a higher rating may be presented as being more relevant than advisors with lower scores. The embodiments are not limited to these examples. If only one advisor is available for a topic, block 608 may be skipped. Otherwise, online host 110 may receive a selection of one of the advisors in the display.

In various embodiments, the logic flow 600 may connect an advisor to the requesting user via a communication interface in block 610. Online host 110 may look up the communication handle of the selected advisor and may use the associated communication medium to communicatively couple the requesting user to the selected advisor. For example, if the communication handle is a chat program handle, online host 110 may contact the chat server via a communication interface and connect the user and the advisor in a chat application provided by the chat server. If the handle is an email address, online host 110 may launch an email program and an email message pre-populated with the advisor's email address.

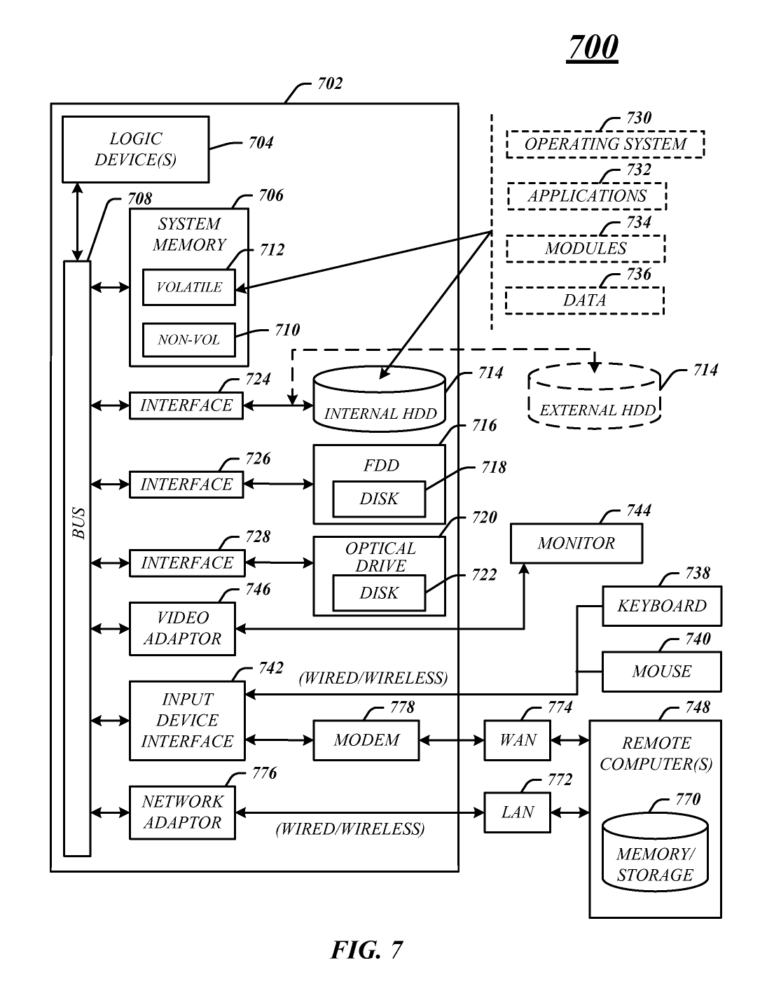

FIG. 7 illustrates a computer architecture in accordance with one or more embodiments, suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises logic device(s) 704, a system memory 706 and a system bus 708. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 704. The system bus 708 provides an interface for system components including, but not limited to, the system memory 706 to the logic device(s) 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, presence detector 302, and communication interface 304.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the logic device(s) 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

References to “one embodiment” or “an embodiment” mean that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computer-implemented method comprising:
registering a first user of a client device as an advisor at an online host, the online host in communication with the client device;
receiving a request for live help on a topic at the online host from a second user viewing a web page;
detecting an advisor for the topic that is online at the online host; and
connecting the detected advisor and the second user for communication using a communication interface in real time.

2. The method of claim 1, further comprising:
detecting a plurality of advisors for the topic that are online;
displaying the detected advisors for selection;
receiving a selection of one of the displayed advisors; and
connecting the selected advisor and the second user for communication.

3. The method of claim 1, wherein registering a user as an advisor comprises:
receiving input from a user selecting to become an advisor;
uniquely identifying the user with a user ID; and
determining at least one topic to associate with the user.

4. The method of claim 3, wherein detecting an advisor comprises at least one of:
receiving a log in from an advisor and retrieving a user ID for the advisor; and
reading a cookie file on the client device.

5. The method of claim 3, further comprising:
storing data about the advisor at the online host, the stored data comprising at least one of: the user ID, a communications handle for the advisor, and a topic area.

6. The method of claim 1, further comprising:
serving pages of a website from the online host.

7. The method of claim 1, wherein the online host is communicatively coupled to a plurality of websites, the method further comprising:
registering users from any of the plurality of websites as advisors at the online host;
detecting an advisor for the topic that is online at any of the plurality of websites; and
communicatively connecting a user that is online at any of the plurality of websites to a detected advisor.

8. The method of claim 1, further comprising:
requesting a user to be an advisor when at least one of:
the user makes a purchase at the online host;
the user views a specific number of pages about one topic at the online host;
the user is online at the online host and another user requests live help; and
the user posts a message on the online host.

9. An apparatus comprising:
a logic device;
an online host operative on the logic device comprising:
a presence detector to detect when an advisor is online at the online host; and to communicatively connect a user that is online at the online host on a client device to an advisor that is online at the online host in response to a request for live help from the user, in real time.

10. The apparatus of claim 9, the presence detector further to request a user to be an advisor when at least one of:
the user makes a purchase at the online host;
the user views a specific number of pages about one topic at the online host;
the user is online at the online host and another user requests live help; and
the user posts a message on the online host.

11. The apparatus of claim 10, the presence detector further to register a user as an advisor by receiving input from a user selecting to become an advisor in response to the request; uniquely identifying the advisor with a user ID; and determining at least one topic to associate with the advisor.

12. The apparatus of claim 11, further comprising:
a storage medium to store data about the advisor at the online host, the stored data comprising at least one of: the user ID, a communications handle for the advisor, and the topic area associated with the advisor.

13. The apparatus of claim 12, the presence detector to detect when an advisor is online by at least one of:
receiving a log in from an advisor, retrieving the user ID for the advisor, and using the user ID to retrieve the stored data about the advisor; and
reading a cookie file on the client device used by the advisor.

14. The apparatus of claim 9, the online host further comprising:
a communication interface to communicatively connect the advisor to the user requesting live help via a third-party communication service.

15. The apparatus of claim 9, wherein the apparatus is communicatively coupled to a plurality of websites, the online host operative to:
register users from any of the plurality of websites as advisors at the online host;
detect an advisor for the topic that is online at any of the plurality of websites; and
to communicatively connect a user that is online at any of the plurality of websites to a detected advisor.

16. A machine-readable storage medium comprising instructions that when executed cause a computing system to:
request a first user viewing a web page via a client device to be an advisor and receive a response;
register the first user as an advisor at an online host when the request is accepted, the online host in communication with the client device;
receive a request for live help on a topic at the online host from a second user viewing a web page;
detecting an advisor for the topic that is online at the online host; and
connecting the detected advisor and the second user for communication in real time.

17. The storage medium of claim 16, further comprising instructions that when executed cause the computing system to detect at least one of:
the user making a purchase at the online host;
the user viewing a specific number of pages about one topic at the online host;
the user being online at the online host when another user requests live help; and
the user posting a message on the online host; and
to request that the user be an advisor upon the detection.

18. The storage medium of claim 17, further comprising instructions that when executed cause the computing system to register a user as an advisor by:
receiving input that the user accepted the request;
uniquely identifying the advisor with a user ID;
determining at least one topic to associate with the advisor; and
storing the topic and a communication handle for the advisor, indexed by the user ID.

19. The storage medium of claim 18, further comprising instructions that when executed cause the computing system to, at least one of:
associate a username and password for the advisor to the user ID; and
write the user ID to a cookie file and place the cookie file on the client device used by the advisor.

20. The storage medium of claim 19, further comprising instructions that when executed cause the computing system to detect when an advisor is online by:
receiving a log in from an advisor or reading a cookie file on the client device used by the advisor;
retrieving the user ID for the advisor; and
using the user ID to retrieve the stored data about the advisor.
